(19) United States
(12) Patent Application Publication
(10) Pub. No.: US 2011/0069156 A1
(43) Pub. Date: Mar. 24, 2011

(54) THREE-DIMENSIONAL IMAGE PICKUP APPARATUS AND METHOD

(75) Inventor: Hidekazu Kurahashi, Saitama (JP)

(73) Assignee: FUJIFILM Corporation, Tokyo (JP)

(21) Appl. No.: 12/888,794

(22) Filed: Sep. 23, 2010

(30) Foreign Application Priority Data
Sep. 24, 2009 (JP) 2009-218772

(51) Int. Cl. H04N 13/02; G06K 9/00

(52) U.S. Cl. 348/47; 382/154; 348/E13.074

(57) ABSTRACT

A three-dimensional camera includes first and second camera units for receiving entry of object light, and for picking up first and second images with parallax simultaneously. First and second lens systems are incorporated in respectively the first and second camera units, and have a focal length changeable for zooming. The focal length of the second lens system is changed toward a wider-angle side than the focal length of the first lens system. A third image is formed from the second image with an angle of view equal to an angle of view of the first image. A three-dimensional image is produced from the first and third images. The first, second and third images are written to a storage medium, or the first and second images and a value of the focal length upon picking up the first image are written to a storage medium.

### BACKGROUND OF THE INVENTION

1. Field of the Invention

The present invention relates to a three-dimensional image pickup apparatus and method. More particularly, the present invention relates to a three-dimensional image pickup apparatus and method in which it is possible reliably to photograph an object which moves at a high speed and simultaneous is framed in a telephoto setting.

2. Description Related to the Prior Art

A three-dimensional camera or three-dimensional image pickup apparatus is known. A first camera unit and a second camera unit pick up images of an object simultaneously. The images with parallax are combined to obtain a three-dimensional image. An example of the three-dimensional camera is described in the following websites.

http://www.fujifilm.co.jp/corporate/news/article/ffnr0226.html

http://www.fujifilm.com/photokina2008/pdf/release/finepix_real3d_e.pdf

An LCD display panel on a rear surface of the three-dimensional camera displays first and second images for being viewed discretely by eyes of a viewer. The viewer can observe the three-dimensional image according to the plural images photographed by the three-dimensional camera autostereoscopically without specific eyewear.

In JP-A 9-005643, a three-dimensional endoscope as the three-dimensional camera is disclosed. The first camera unit has a wide-angle first lens system with a small first focal length. The second camera unit has a second lens system of a normal angle of view with a great second focal length. The first and second camera units pick up images of common the object. An image processor corrects the first image from the first camera unit for an equivalent angle of view after the second camera unit of the normal angle of view in an apparent manner. A second image from the second camera unit and the corrected image are combined with one another, viewed by the viewer's eyes, to photograph the object stereoscopically. In the endoscope, the first camera unit of the wide-angle setting is used at first for image pickup of a large area for searching the object. Then the second camera unit of the normal angle of view is used together for detailed observation, so that a small area in the body cavity is enlarged for three-dimensional image pickup.

U.S. Pat. No. 7,701,491 (corresponding to JP-A 2006-211489) discloses the three-dimensional camera for obtaining plural images at one time with a difference in the angle of view. It is possible with the three-dimensional camera to obtaining a first image without trimming and a second image of a telephoto view according partial trimming of the first image.

There is a special scene in which the object moves very quickly and is followed for image pickup in a telephoto setting. If a user is rather unskilled, the object abruptly comes out of a viewing area of the three-dimensional camera when he or she depresses the shutter. It is likely that the object is missed in the image pickup in spite of his or her intention. There may be great importance of image pickup of the object even from a scene with high difficulty in photographing the object.

In JP-A 9-005643, the image pickup can be changed over between the two-dimensional image mode of a wide-angle setting and the three-dimensional image mode of the normal angle of view in a telephoto setting. If a user wishes to keep an image of the object, possibility of photographing the object in a viewing area will be high upon changeover to the two-dimensional image mode of the wide-angle setting. However, the object may be incidentally missed from the viewing area even after attempt of photographing the object in the three-dimensional image mode of the normal angle of view in the telephoto setting. Such a problem cannot be prevented reliably.

In U.S. P. No. 7,701,491 (corresponding to JP-A 2006-211489), images handled for display of live images are stored. Should the object be missed from an image of a telephoto setting according to the trimming, there is possibility of presence of the object in an image without trimming according to handling for live images. However, the images for live images are field images having only considerably low image quality in comparison with frame images which are generally used for main image pickup.

### SUMMARY OF THE INVENTION

In view of the foregoing problems, an object of the present invention is to provide a three-dimensional image pickup apparatus and method in which it is possible reliably to photograph an object which moves at a high speed and simultaneous is framed in a telephoto setting.

In order to achieve the above and other objects and advantages of this invention, a three-dimensional image pickup apparatus is provided, and includes first and second camera units for receiving entry of object light, and for picking up first and second images with parallax simultaneously. First and second lens systems are incorporated in respectively the first and second camera units, and have a focal length changeable in a zooming range for zooming. A focal length adjusting device changes the focal length of the second lens system toward a wider-angle side than the focal length of the first lens system. A processor forms a third image from the second image with an angle of view equal to an angle of view of the first image. A three-dimensional image processor produces a three-dimensional image from the first and third images. There is a medium controller for storage processing of the first, second and third images, or the first and second images and a value of the focal length upon picking up the first image.

The processor forms the third image by trimming of the second image.

The focal length adjusting device enlarges a lens moving distance for zooming the second lens system toward a wide-angle side according to zooming of the first lens system toward a telephoto end position.

The zooming range is equal between the first and second lens systems. The focal length adjusting device, if the first lens system is in a wide-angle end position in the zooming range, sets the second lens system in a wide-angle end position, and if the first lens system is deviated from the wide-angle end position, sets the second lens system nearer to the wide-angle end position than the first lens system.

Furthermore, a number input device inputs a pixel number of pixels of an image for storage processing with the medium controller, to change a lens moving distance for zooming the second lens system toward a wide-angle side according to the pixel number.

Furthermore, a principal object detector detects a principal object from the first image, to change a lens moving distance for zooming the second lens system toward a wide-angle side if the principal object is in a first condition.

The first condition is at least one selected from a group including a condition in which the principal object is positioned at an end of the first image, a condition of the principal object with motion, and a condition in which an object distance of the principal object is equal to or smaller than a predetermined distance.

Also, a three-dimensional image pickup method is provided, and includes a step of picking up first and second images with parallax simultaneously by use of first and second camera units including respectively first and second lens systems of which a focal length is changeable in a zooming range for zooming. The focal length of the second lens system is changed toward a wider-angle side than the focal length of the first lens system. A third image is formed from the second image with an angle of view equal to an angle of view of the first image. A three-dimensional image is produced from the first and third images. The first, second and third images are written to a storage medium, or the first and second images and a value of the focal length upon picking up the first image are written to a storage medium.

The third image is formed by trimming of the second image.

In the changing step for the focal length, a lens moving distance for zooming the second lens system toward a wide-angle side is enlarged according to zooming of the first lens system toward a telephoto end position.

The zooming range is equal between the first and second lens systems. In the changing step for the focal length, if the first lens system is in a wide-angle end position in the zooming range, the second lens system is set in a wide-angle end position, and if the first lens system is deviated from the wide-angle end position, the second lens system is set nearer to the wide-angle end position than the first lens system.

Furthermore, there is a step of determining a pixel number of pixels of an image in the storing step, to change a lens moving distance for zooming the second lens system toward a wide-angle side according to the pixel number.

Furthermore, there is a step of detecting a principal object from the first image, to change a lens moving distance for zooming the second lens system toward a wide-angle side if the principal object is in a first condition.

The first condition is at least one selected from a group including a condition in which the principal object is positioned at an end of the first image, a condition of the principal object with motion, and a condition in which an object distance of the principal object is equal to or smaller than a predetermined distance.

Also, a computer executable program for three-dimensional image pickup is provided, and includes a program code for picking up first and second images with parallax simultaneously by use of first and second camera units including respectively first and second lens systems of which a focal length is changeable in a zooming range for zooming. A program code is for changing the focal length of the second lens system toward a wider-angle side than the focal length of the first lens system. A program code is for forming a third image from the second image with an angle of view equal to an angle of view of the first image. A program code is for producing a three-dimensional image from the first and third images. A program code is for writing the first, second and third images to a storage medium, or the first and second images and a value of the focal length upon picking up the first image to a storage medium.

Also, a user interface for three-dimensional image pickup is provided, and includes a region for picking up first and second images with parallax simultaneously by use of first and second camera units including respectively first and second lens systems of which a focal length is changeable in a zooming range for zooming. A region is for changing the focal length of the second lens system toward a wider-angle side than the focal length of the first lens system. A region is for forming a third image from the second image with an angle of view equal to an angle of view of the first image. A region is for producing a three-dimensional image from the first and third images. A region is for writing the first, second and third images to a storage medium, or the first and second images and a value of the focal length upon picking up the first image to a storage medium.

Consequently, it is possible reliably to photograph an object which moves at a high speed and simultaneous is framed in a telephoto setting, because the use of the third image formed by wide-angle setting of the second lens system can cause enhanced viewing.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a three-dimensional camera;

FIG. 2 is a perspective view illustrating the three-dimensional camera;

FIG. 3A is an explanatory view illustrating right and left eye images;

FIG. 3B is an explanatory view illustrating a state of viewing the images of FIG. 3A to clarify stereoscopy;

FIG. 4 is a block diagram schematically illustrating the three-dimensional camera;

FIG. 5 is a flow chart illustrating a sequence in a three-dimensional still image mode;

FIG. 6A is an explanatory view illustrating a first image formed through the first lens system in a wide-angle setting;

FIG. 6B is an explanatory view illustrating lens movement of the lens groups in the second lens system at the time of FIG. 6A; and

FIGS. 7A and 7B are explanatory views illustrating lens movement of the lens groups in the second lens system in a telephoto setting;

FIG. 8 is a block diagram schematically illustrating a second preferred three-dimensional camera;

FIG. 9 is a flow chart illustrating a sequence in the three-dimensional still image mode;

FIG. 10A is an explanatory view illustrating a first image formed through the first lens system in a state of a large number of pixels;

FIG. 10B is an explanatory view illustrating lens movement of the lens groups in the second lens system at the time of FIG. 10A;

FIGS. 11A and 11B are explanatory views illustrating lens movement of the lens groups in the second lens system in a state of a small number of pixels;

FIG. 12 is a block diagram schematically illustrating a third preferred three-dimensional camera;

FIG. 13 is a flow chart illustrating a sequence in the three-dimensional still image mode;

FIG. 14A is an explanatory view illustrating a first image formed through the first lens system in presence of the object at the center;

FIG. 14B is an explanatory view illustrating lens movement of the lens groups in the second lens system at the time of FIG. 14A; and

FIGS. 15A and 15B are explanatory views illustrating lens movement of the lens groups in the second lens system in presence of the object at a frame end.

### DETAILED DESCRIPTION OF THE PREFERRED EMBODIMENT(S) OF THE PRESENT INVENTION

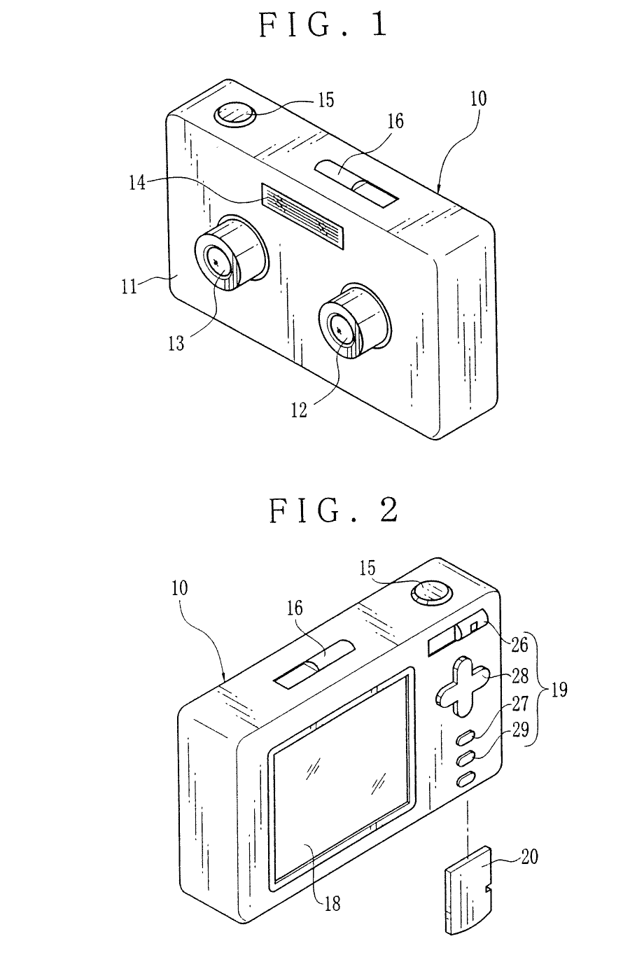

In FIG. 1, a three-dimensional camera 10 or stereoscopic camera is illustrated. A camera body 11 of the three-dimensional camera 10 has a front surface. There are a first camera unit 12, a second camera unit 13, and a flash light source 14 arranged on the front surface. The first and second camera units 12 and 13 are arranged to set their optical axes parallel with one another. A shutter button 15 and a power switch 16 are disposed on an upper side of the camera body 11.

In FIG. 2, an LCD or display panel 18 and an input panel 19 are disposed on a rear surface of the camera body 11. A card slot (not shown) is disposed on a lower surface of the camera body 11. A memory card 20 as storage medium is removably loaded in the card slot. A lid is disposed to close a lower opening of the card slot.

In the three-dimensional camera 10, the first and second camera units 12 and 13 pick up images of one object from points with a small distance, and with parallax. The display panel 18 is used to reproduce and display the two images for a viewer's eyes to view those in a discrete manner. Thus, a three-dimensional image is displayed for the viewer.

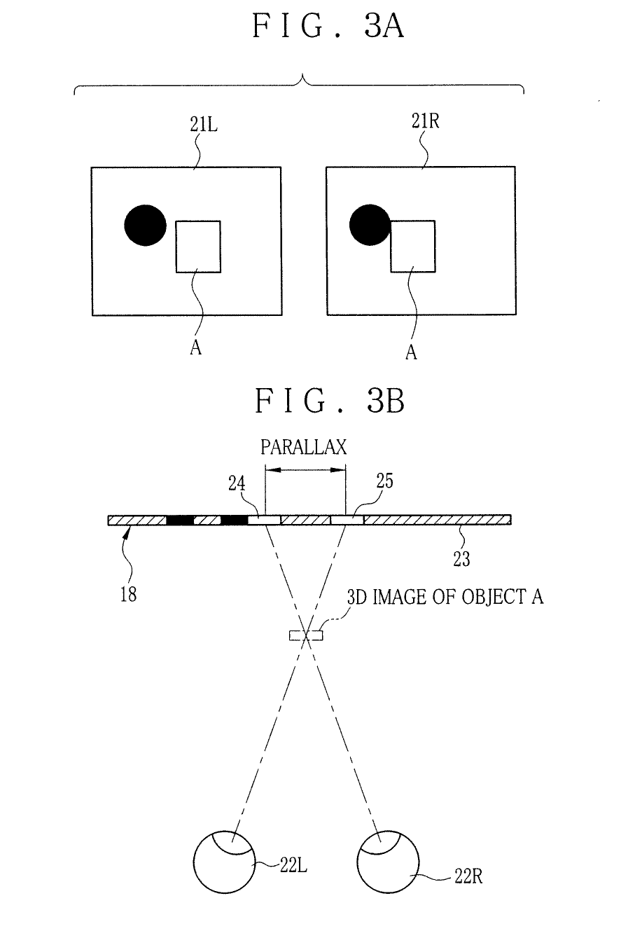

In FIGS. 3A and 3B, a view of a three-dimensional image on the display panel 18 is illustrated. In FIG. 3A, right and left eye images 21L and 21R are depicted. In FIG. 3B, a state of the view is depicted. Right and left eyes 22L and 22R of the viewer view the images. A display surface 23 of the display panel 18 displays the right and left eye images 21L and 21R in a combined manner. In FIG. 3A, an object 24 or object A appears in the right eye image 21R. In FIG. 3B, an object 25 or object A appears in the left eye image 21L. In FIG. 3B, a position of the object A is deviated at an amount of the parallax. Lines of eye gaze of the viewer cross over one another at a point in front of the display surface 23. An image of the object A apparently protrudes forwards to give a stereoscopic form.

To clarify the description of a three-dimensional image, the right and left eye images 21L and 21R have one viewing area. Namely, a magnification of zooming is equal between the first and second camera units 12 and 13. In the embodiment, a viewing area of the second camera unit 13 is set larger than a viewing area of the first camera unit 12 (zoomed toward the wide-angle side). A viewing area of the first camera unit 12 is retrieved by trimming from a viewing area of the second camera unit 13 to form right and left images for stereoscopy. Even when an object is missed from the viewing area of the first camera unit 12, probability of presence of the object in a viewing area with the second camera unit 13 is increased, to prevent missing of the object in the two-dimensional image. The two-dimensional image has a sufficiently high image quality, because of image data of a frame image for recording instead of image data of a field image for use as a live image.

During standby for image pickup, the display panel 18 is an electronic viewfinder for displaying a live image of a three-dimensional or two-dimensional form. For the reproduction, the display panel 18 displays an image two or three-dimensionally according to image data stored in the memory card 20.

The input panel 19 includes a mode designation switch 26, a menu button 27, a cross shaped key 28 and a start key 29. The mode designation switch 26 is operable for changing over the operation modes of the three-dimensional camera 10. The operation modes include a two-dimensional still image mode, a two-dimensional moving image mode, a three-dimensional still image mode, a three-dimensional moving image mode and a reproduction mode. In the two-dimensional still image mode, a two-dimensional still image is picked up. In the two-dimensional moving image mode, a two-dimensional moving image is picked up. In the three-dimensional still image mode, a three-dimensional still image is picked up. In the three-dimensional moving image mode, a three-dimensional moving image is picked up. In the reproduction mode, any of the images obtained by image pickup is displayed on the display panel 18. In a default status directly after turning on the power switch 16, the three-dimensional still image mode is set.

The menu button 27 is operated to display information on the display panel 18, such as a menu screen and input screen. The cross shaped key 28 is operated to zoom the first and second camera units 12 and 13 and to move a cursor displayed in the menu screen and input screen. The start key 29 is depressed to confirm a condition or mode set in the camera.

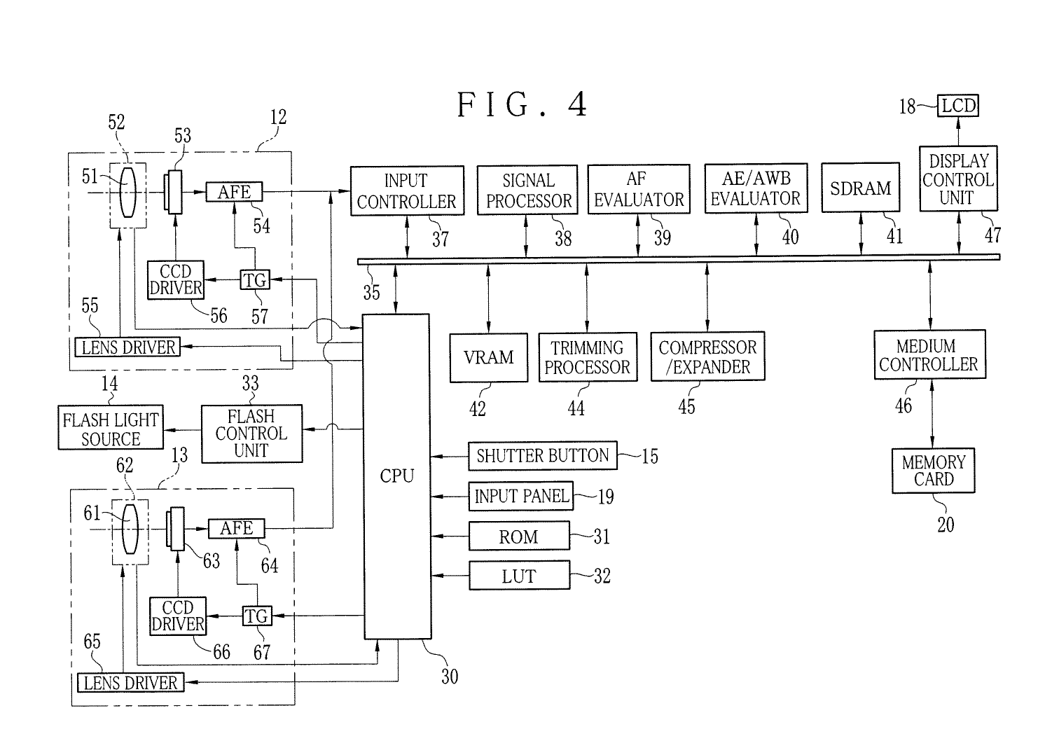

In FIG. 4, circuit elements in the three-dimensional camera 10 are illustrated. A CPU 30 operates in response to input signals from the shutter button 15 and the input panel 19. A ROM 31 stores various programs and data. The CPU 30 reads the programs and data, and controls the circuit elements entirely by running the programs. A look-up table memory 32 or LUT is connected to the CPU 30 as described later. A flash control unit 33 is connected with the CPU 30 and controls the flash light source 14.

A data bus 35 connects various elements to the CPU 30. The elements include an input controller 37, a signal processor 38, an AF evaluator 39, an AE/AWB evaluator 40, an SDRAM 41, a VRAM 42, a trimming processor 44 as processor for a third image, a compressor/expander 45, a medium controller 46 and a display control unit 47 as three-dimensional image processor. Also, the first and second camera units 12 and 13, the shutter button 15, the input panel 19, the ROM 31, the look-up table memory 32 and the flash control unit 33 are connected to the CPU 30.

The shutter button 15 is a two step switch, and depressible at two levels by half depression and full depression. In the still image mode, the shutter button 15 is depressed halfway to perform tasks required for image pickup, for example, AE (auto exposure) control, AF (autofocus) control, AWB (automatic white balance) control, and the like. When the shutter button 15 is depressed fully, a still image is picked up and stored. In the moving image mode, the shutter button 15 is depressed fully to start recording a moving image. When the shutter button 15 is depressed fully again, the image pickup of the moving image is terminated.

The first camera unit 12 includes a first lens system 52, a CCD image sensor 53 and an AFE or analog front end 54. Lenses/lens groups 51 as focal length adjusting device are incorporated in the first lens system 52 as a zoom lens system of which a focal length is changeable in a zoom range. Also, an MOS image sensor may be used instead of the CCD image sensor.

The first lens system 52 includes various elements, such as the lens groups 51, a zoom mechanism, focusing mechanism, aperture stop device and the like. The zoom mechanism drives the lens groups 51 for zooming. A focal length of the lens groups 51 is fed back to the CPU 30. The focusing mechanism moves the focus lens in the lens groups 51 for adjusting the focus. The aperture stop device adjusts a diameter of its opening to adjust strength of object light incident on the CCD image sensor 53. A lens driver 55 is controlled by the CPU 30 to actuate the zoom mechanism, the focusing mechanism and the aperture stop device.

The CCD image sensor 53 converts object light from the lens groups 51 into an image signal as an output. A CCD driver 56 is connected with the CCD image sensor 53, and controlled by the CPU 30. A timing generator 57 or TG generates a sync pulse with which the CCD driver 56 is driven, and controls charge storing time and transfer timing of charge reading of the CCD image sensor 53.

An image signal generated by the CCD image sensor 53 is input to the analog front end 54. The analog front end 54 includes a correlated double sampling circuit, an automatic gain control circuit, and an A/D converter. When the sync pulse is generated by the timing generator 57, responsively the analog front end 54 operates in synchronism with transfer in the CCD image sensor 53 in charge reading. The correlated double sampling circuit eliminates noise from the image signal. The automatic gain control circuit amplifiers the image signal at an input gain according to sensitivity determined by the CPU 30. The A/D converter converts the image signal of the analog form from the automatic gain control circuit into a first image signal of a digital form, which is input to the input controller 37.

The second camera unit 13 is structurally equal to the first camera unit 12, and includes a second lens system 62, a CCD image sensor 63, an AFE or analog front end 64, a lens driver 65, a CCD driver 66 and a timing generator 67 or TG. Lenses/lens groups 61 as focal length adjusting device are incorporated in the second lens system 62 in the same manner as the lens groups 51. A second image signal is output by the analog front end 64 to the input controller 37.

In the second camera unit 13, the CPU 30 obtains the focal length of the lens groups 51 fed back from the first lens system 52, and zooms the lens groups 61 in the second camera unit 13 at a focal length which is on a wider-angle side than the obtained focal length. The distance of the zooming changes according to the focal length of the lens groups 51. A difference of the focal length of the lens groups 61 from that of the lens groups 51, when the zoom position of the lens groups 51 is on the wide-angle side, is set small, and when the zoom position of the lens groups 51 is on the telephoto side, is set large.

For the image pickup on the telephoto side, the viewing area of the second camera unit 13 is set larger than the viewing area of the first camera unit 12 for enhanced viewing, which increases probability of presence of an object within the viewing area of the second camera unit 13 even upon missing of the object from the viewing area of the first camera unit 12. However, when the lens groups 51 are set in the wide-angle end position (shortest focal length), the lens groups 61 are also set equally with the lens groups 51, because the focal length of the lens groups 61 cannot be changed toward the wide-angle side in comparison with the shortest focal length of the lens groups 51, and because there is low probability in missing of an object from the viewing area in the image pickup of the wide-angle end position (widest angle side). A relationship between focal lengths of the lens groups 51 and 61 is stored in the look-up table memory 32, and is read by the CPU 30 for suitable situations.

The input controller 37 has a buffer with a predetermined capacity, and stores first and second images signals output by the first and second camera units 12 and 13. Directly after the power switch 16 is turned on or upon halfway depression of the shutter button 15 for display of a live image, the input controller 37 sends the image signals of one field of storing to the signal processor 38. When the shutter button 15 is depressed fully for recording by image pickup, the input controller 37 sends first and second signals of one frame being stored to the signal processor 38.

The signal processor 38 processes the first and second image signals from the input controller 37 for various processing functions such as gradation conversion, white balance correction, gamma correction, Y-C conversion and the like, to form first and second image data corresponding to images of one field or one frame. The first and second image data are written to the VRAM 42.

The AF evaluator 39 determines an AF evaluation value of information of the contrast for each of the first and second images according to the first and second image signals from the input controller 37. The CPU 30 controls the lens drivers 55 and 65 according to the AF evaluation value from the AF evaluator 39 to adjust focus of the lens groups 51 and 61.

The AE/AWB evaluator 40 detects object brightness and determines a WB evaluation value for use in the white balance correction in accordance with the first and second image signals. The CPU 30 controls the lens drivers 55 and 65 and the CCD drivers 56 and 66 according to information of the object brightness from the AE/AWB evaluator 40 to control the exposure. Also, the CPU 30 controls the signal processor 38 to optimize the white balance of an object according to the WB evaluation value from the AE/AWB evaluator 40.

The trimming processor 44 is controlled by the CPU 30 and reads second image data from the VRAM 42, to retrieve a third image from the second image at an area equal to that of the first image. Details of the retrieval will be described later.

For a main sequence of image pickup, the compressor/expander 45 compresses image data stored in the SDRAM 41, the image data including the first and second image data, and the third image data produced by trimming of the second image data, to produce the first, second and third compressed image data of a predetermined file format. If the angle of view is set according to the wide-angle end position, the third image data is equal to the second image data.

The first, second and third compressed image data are written by the medium controller 46 to the memory card 20. To reproduce images, the compressor/expander 45 expands the first, second and third compressed image data from the memory card 20, to create first, second and third uncompressed image data. The medium controller 46 accesses the memory card 20 to write and read image data.

The display control unit 47 processes the first and third image data from the VRAM 42, or uncompressed form of the first and third image data expanded by the compressor/expander 45, to form a signal for image display by signal processing. The signal is output to the display panel 18 in a preset sequence. Thus, the first and third images are displayed on the display panel 18 in a three-dimensional still image mode as a default mode. A user can view a three-dimensional live image.

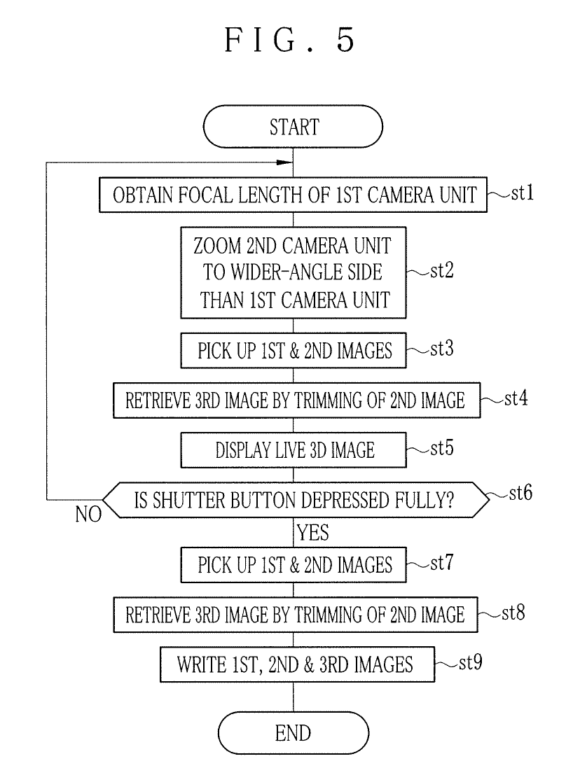

The operation of the three-dimensional camera 10 is described by referring to FIGS. 5-7B. At first, the power switch 16 is operated to turn on the power source of the three-dimensional camera 10. In a default state immediately after powering, the three-dimensional still image mode is set in the three-dimensional camera 10. The first and second camera units 12 and 13 start picking up a live image.

When horizontal bars in the cross shaped key 28 are depressed for zooming, the first lens system 52 of the first camera unit 12 is controlled to change the focal length of the lens groups 51. The focal length is fed back to the CPU 30 from the first lens system 52. See the step st1.

The CPU 30 refers to the look-up table memory 32 according to the focal length of the lens groups 51 output by the first lens system 52, and controls the second lens system 62 in the second camera unit 13 to set the lens groups 61 at a focal length of a wider-angle side than the lens groups 51. See the step st2.

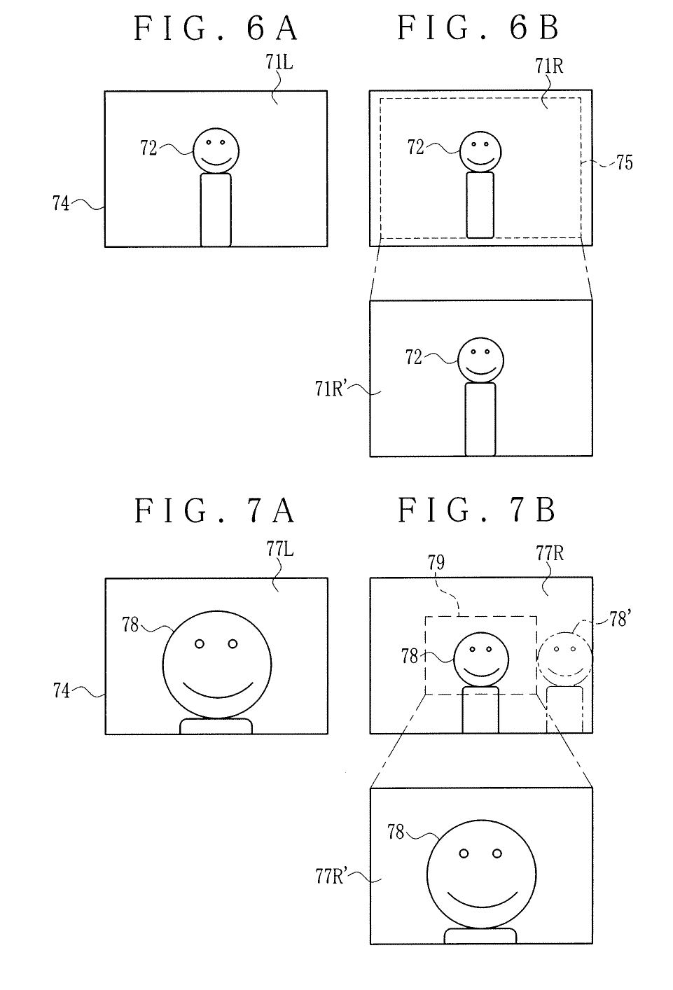

When the lens groups 51 are zoomed to the wide-angle side, likeliness of missing of an object 72 from a frame 74 is considerably low, the object 72 being present in a first image 71L (of a field image) output by the first camera unit 12. Thus, the focal length of the lens groups 61 becomes shorter toward the wide-angle side than that of the lens groups 51. In FIG. 6B, a second image 71R (of a field image) output by the second camera unit 13 has a region slightly greater than the first image 71L.

Image data of the first and second images 71L and 71R as field images output by the first and second camera units 12 and 13 in synchronism are input to the input controller 37, processed by the signal processor 38 for various functions of signal processing, and written to the VRAM 42 in the step st3.

The trimming processor 44 reads image data of the second image 71R output by the second camera unit 13. The second image 71R is processed for trimming in a trimming area or crop area 75 (indicated by the broken line) according to the first image 71L. Image data of a third image 71R′ (of a field image) is obtained and written to the VRAM 42. See the step st4.

Image data of the first and third images 71L and 71R′ are read from the VRAM 42, and output by the display control unit 47 to the display panel 18. As there is parallax between the first and third images 71L and 71R′, a three-dimensional live image can be seen on the display panel 18. See the step st5.

When the input panel 19 is left to stand without manual touch for a predetermined time, for example one minute, the display panel 18 is turned to an energy saving mode of display and comes not to display a live image. A user can depress the shutter button 15 halfway for the display panel 18 to restart displaying the live image again.

A first image 77L is output by the first camera unit 12 as a field image. See FIG. 7A. When the lens groups 51 are zoomed to the telephoto side, an object 78 in the first image 77L is very likely to extend outside the frame 74. The likeliness is specifically high if motion of the object 78 is quick. Thus, a focal length of the lens groups 61 is changed considerably to the wider-angle side than the focal length of the lens groups 51. In FIG. 73, a second image 77R as a field image is output by the second camera unit 13, and covers a larger area than the first image 77L.

The image data of the first and second images 77L and 77R output by the first and second camera units 12 and 13 in synchronism are input by the input controller 37, processed by the signal processor 38 for various functions of signal processing, and written to the VRAM 42. See the step st3.

Image data of the second image 77R is read by the trimming processor 44. A trimming area or crop area 79 is determined to correspond to a viewing area of the first image 77L. The image data of the second image 77R is processed by trimming with the trimming area 79. A third image 77R′ is obtained as a field image, of which image data is written to the VRAM 42. See the step st4. The third image on the telephoto side has a high magnification of enlargement. So image data having passed through a low-pass filter is used because a component of high frequency should be treated as noise.

The image data of the first and third images 77L and 77R′ are read from the VRAM 42, and output by the display control unit 47 to the display panel 18. A user can view a three-dimensional live image on the display panel 18 at the step st5 because of parallax between the first and third images 77L and 77R′.

He or she views the object 78 on the display panel 18, and depresses the shutter button 15 fully at the step st6. Image data of first and second images as frame images output by the first and second camera units 12 and 13 in synchronism are sent through the input controller 37 and the signal processor 38 and written to the SDRAM 41. See the step st7.

The trimming processor 44 reads the second image from the SDRAM 41, processes the second image for trimming in a trimming area according to a viewing area of the first image, to produce image data of a third image, and outputs the image data to the SDRAM 41. See the step st8. The first, second and third images are compressed as one image file in a predetermined file format by the compressor/expander 45. The medium controller 46 writes the image file to the memory card 20 in the step st9.

The images may be stored in a different manner. For example, information of a tab can be created to associate the images with one another before storing in the memory card 20. Also, it is possible in the memory card 20 to store a set of the first and second images and a focal length of the lens groups 51 at the time of image pickup of the first image instead of the first to third images. To reproduce a three-dimensional image, the second image is processed by trimming according to the focal length of the lens groups 51 to form the third image.

The shutter button 15 is depressed after zooming the lens groups 51 on the telephoto side. It is likely upon the depression of the shutter button 15 that the object 78 moves abruptly and becomes missed from a viewing area for a first image. Even though the object 78 is not present in an area viewable for a three-dimensional image, it is probable that an object 78′ is present in a viewing area for a second image from the second camera unit 13 in a two-dimensional form (frame image).

Even if the object 78 has not been photographed as a three-dimensional image, it is probable to keep an image of the object 78′ as two-dimensional image, and to prevent unwanted missing of the object 78 in image pickup. The two-dimensional image, according to image data of a frame image, has a sufficiently high image quality.

In the two-dimensional still image mode, the first image from the first camera unit 12 is a main image. The second image from the second camera unit 13 synchronized with the first camera unit 12 is an auxiliary image. The main and subsidiary images are written to the memory card 20. Except for the setting of the wide-angle end position (widest angle side), an area in the subsidiary image is always wider than that in the main image. This is effective in enhanced viewing, as it is highly probable that an object missed in the main image may be present in the subsidiary image.

A sequence in the three-dimensional moving image mode is similar to the three-dimensional still image mode. Image data of a three-dimensional moving image at a magnification set by a user is stored in the memory card 20. Also, image data of a two-dimensional moving image from the second camera unit 13 upon image pickup with a greater angle of view than the three-dimensional moving image is stored in the memory card 20 in association with the three-dimensional moving image. Consequently, it is probable that an object is present in the two-dimensional moving image even after missing in the three-dimensional moving image.

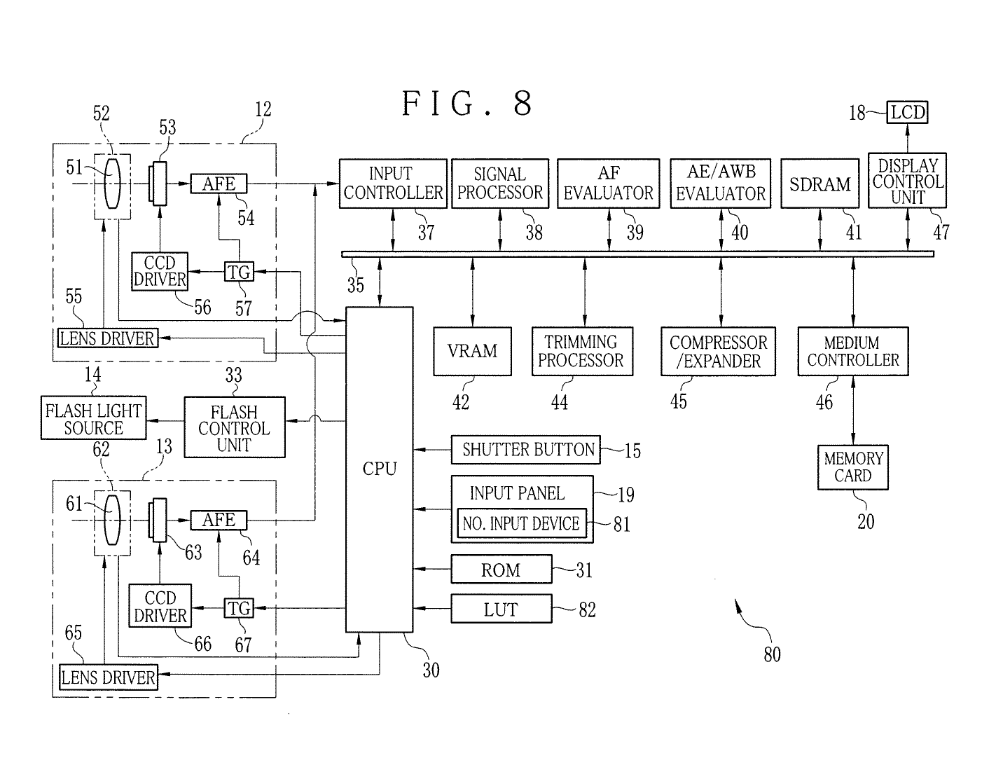

In FIG. 8, a second preferred three-dimensional camera 80 or stereoscopic camera is illustrated. The three-dimensional camera 80 is characterized in that a change amount of the angle of view of an image for enhanced viewing (second image) is changed according to the number of pixels for an image to be written to the memory card 20.

For the three-dimensional camera 80, the three-dimensional camera 10 is repeated except for having a number input device 81 for inputting an active pixel number, and a look-up table memory 82 or LUT in FIG. 18. The number input device 81 sets the number of pixels to the input panel 19. The look-up table memory 82 is instead of the look-up table memory 32. Elements similar to those of the first embodiment are designated with reference numerals.

According to the data in the look-up table memory 82, a lens moving distance for shift of an angle of view of the second image toward the wide-angle side becomes larger than a lens moving distance for shift of the angle of view of the first image according to zooming of the first image toward the telephoto side. This is the same as the condition of the first embodiment. However, the number of pixels is set smaller to lower the image quality relatively. Even if an enlargement factor is increased by increasing the ratio of the trimming, only small influence occurs to the drop of the image quality. In the present embodiment, a lens moving distance for shift of an angle of view of the second image toward the wide-angle side according to zooming of the first image toward the telephoto side is determined by referring to smallness of the input number of pixels, at a higher level than that according to the first embodiment, so as to increase probability of presence of an object within the second image. Note that a plurality of predetermined values of pixel numbers are stored and selectively designated. However, an adjusting structure can be incorporated for a user to determine a pixel number in a predetermined range.

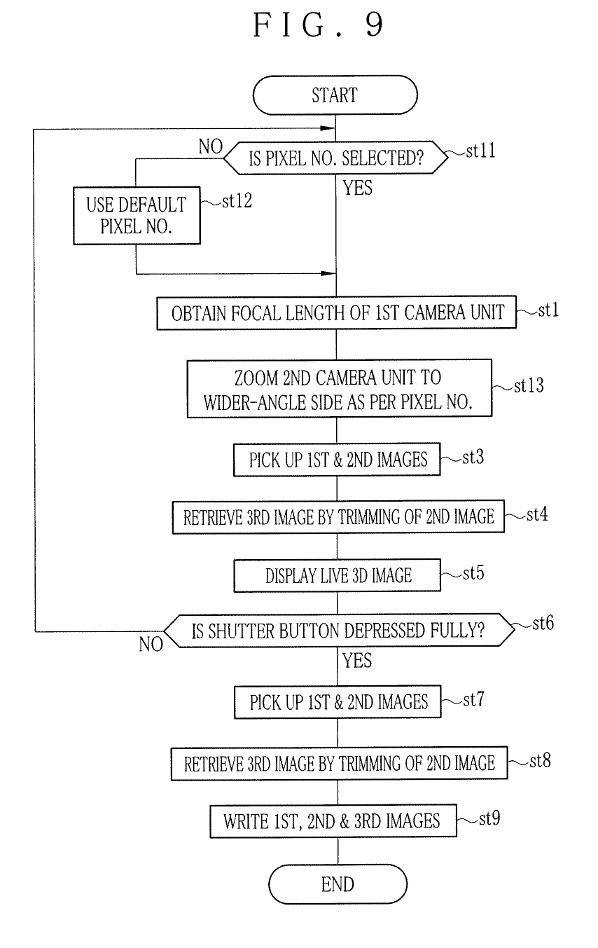

He or she selects one of plural numbers of pixels before start. See the step st11. If he or she does not determine the number, a default number of pixels preset in the three-dimensional camera 80 is used. See the step st12. Note that signs st11 and the like correspond to the signs st11 and others in the flow chart of FIG. 9. Steps similar to those of the above embodiment are designated with identical signs or numbers.

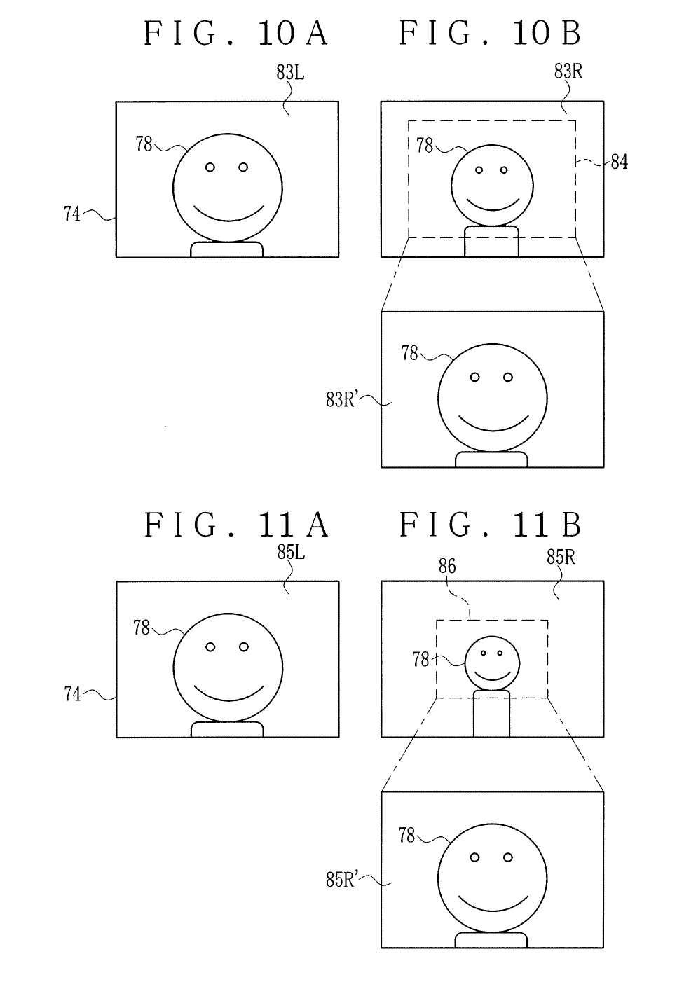

When the user selects a high number as a pixel number for a relatively high resolution, a first image 83L of FIG. 10A is obtained from the first camera unit 12. A second image 83R of FIG. 10B is obtained from the second camera unit 13. A lens moving distance for zooming of the second image 83R from the angle of view of the first image 83L to the wide-angle side is set smaller. See the step st13. Thus, there occurs small drop in resolution of an enlarged third image 83R′ according to a trimming area or crop area 84 in the second image 83R. A three-dimensional image observable on the display panel 18 with simultaneous display of the first and third images 83L and 83R′ can have a high image quality with high resolution.

When the user selects a low number as a pixel number for a relatively low resolution, a first image 85L of FIG. 11A is obtained from the first camera unit 12. A second image 85R of FIG. 11B is obtained from the second camera unit 13. A lens moving distance for zooming of the second image 85R from the angle of view of the first image 85L to the wide-angle side is set larger. See the step st13. A viewing area of the second image 85R can be still larger, and increases possibility of presence of the object 78 in the second image 85R even after missing from the first image 85L. Thus, there occurs considerable drop in resolution of an enlarged third image 85R′ according to a trimming area or crop area 86 in the second image 85R. However, there is no conspicuous drop in the resolution of a three-dimensional image displayed on the display panel 18 with the first and third images 85L and 85R′, because resolution of the first image 85L is low.

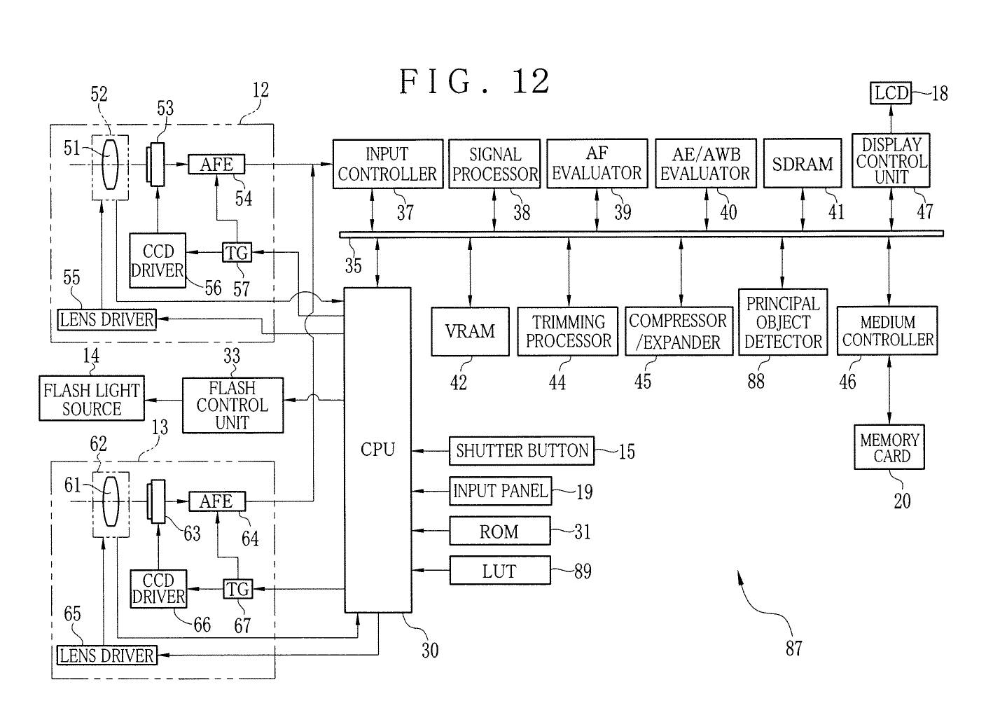

In FIG. 12, a third preferred three-dimensional camera 87 or stereoscopic camera is illustrated. An offset amount of the angle of view of a second image as an image for enhanced viewing is changed according to a condition of a principal object. The condition is likeliness of coming away of a principal object from an viewing area. Specifically, the condition is nearness of the principal object to a frame end of the viewing area, or location of the principal object within a near distance as small as 2 meters from the three-dimensional camera 87, or quick motion of the principal object.

For the three-dimensional camera 87, the three-dimensional camera 10 is repeated except for having a principal object detector 88 and a look-up table memory 89. The principal object detector 88 detects a principal object from a viewing area of framing. The look-up table memory 89 is used in place of the look-up table memory 32.

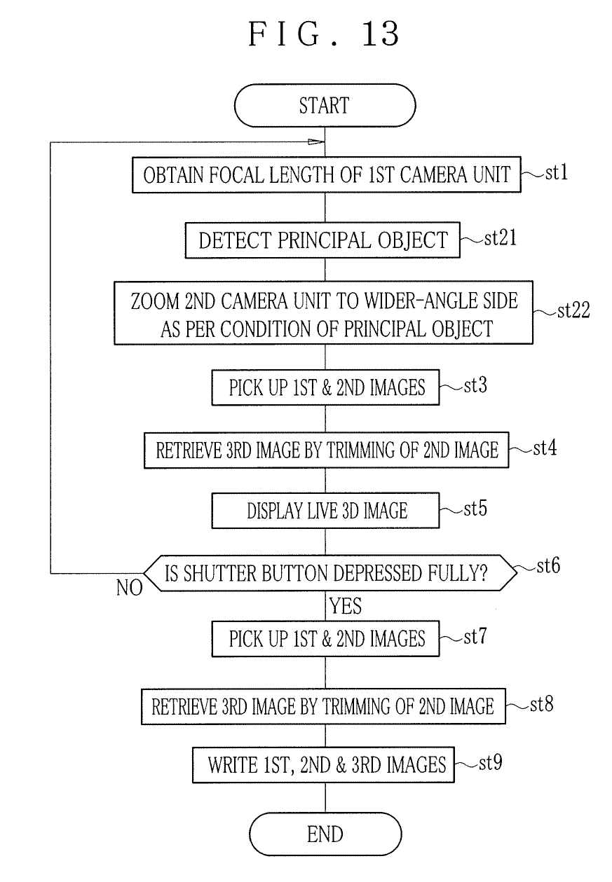

A first image 91L is obtained by the first camera unit 12 in FIG. 14A. The principal object detector 88 detects a face 92a from the first image 91L, and determines a principal object 92 according to the face 92a in the step st21. If plural faces are detected in the first image 91L, one of those with a largest area is regarded as the principal object 92. Note that signs st21 and the like correspond to the signs st21 and others in the flowchart of FIG. 13. Steps similar to those of the above embodiment are designated with identical signs or numbers.

For the face detection, candidate pixels of flesh color are extracted from all of the pixels in each image. The extracted pixels are combined to obtain flesh color portions in the image. The flesh color portions are compared with template information of a face according to a known technique of pattern recognition, and are evaluated for presence or absence of a face according to a result of the comparison. Furthermore, an area of the flesh color portions is compared to a threshold area. If the area is equal to or more than the threshold area, the flesh color portions are determined as a face. Also, a known technique of pattern recognition can be used to extracting eyes, a mouth or other specific parts of a face are extracted for the face detection.

Then the CPU 30 evaluates the condition of the principal object 92. In FIG. 14A, the principal object 92 does not shift in the presence at the center of the first image 91L. The CPU 30 refers to the look-up table memory 89, and changes the focal length of the lens groups 61 slightly farther toward the wide-angle side than the focal length of the lens groups 51 to set the lens groups 61. See the step st22. Thus, a second image 91R is obtained from the second camera unit 13 as illustrated in FIG. 14B. A third image 91R′ from a trimming area or crop area 93 in the second image 91R has a low enlargement factor, has small degradation, so that a three-dimensional image of a high quality can be viewed.

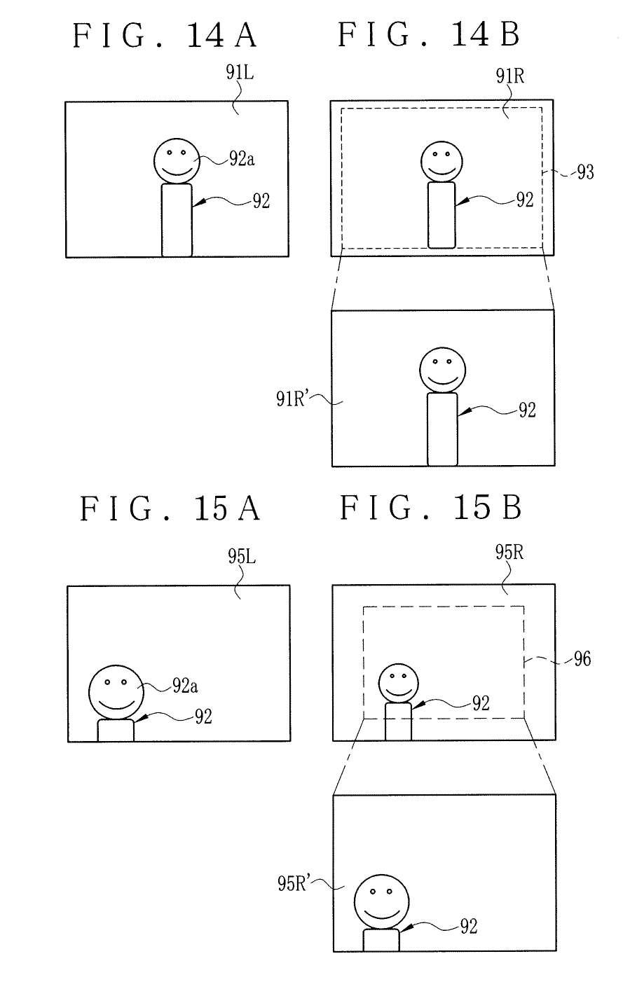

In FIG. 15A, a first image 95L is illustrated. The principal object 92 is present near to an end of the first image 95L. It is likely that the principal object 92 is missed from the area of the first image 95L. Thus, the CPU 30 refers to the look-up table memory 89 and changes the focal length of the lens groups 61 to a considerably wider-angle side than that of the lens groups 51. See the step st22.

Also, when the principal object 92 is moving or is located at a very near distance, the focal length of the lens groups 61 is changed toward the wider-angle side than the that of the lens groups 51. An active or inactive state of motion of the principal object 92 can be found according to a position of the principal object 92 in a plurality of successive frames of a live image. For a location of the principal object 92 at a very near distance or within a distance of 2 meters, an output from the AF evaluator 39 can be checked for the evaluation.

In FIG. 15B, a second image 95R is obtained by the second camera unit 13 at a sufficiently larger angle of view than the first image 95L. It is very probable that the principal object 92 is present in the second image 95R even if the principal object 92 moves slightly or if a camera shake occurs with a user's hand. The display panel 18 displays the first image 95L and an enlarged third image 95R′ according to a trimming area 96 of the second image 95R, so that he or she can view a three-dimensional image of the principal object 92.

Also, it is possible in the present embodiment to add the structure for changing a lens moving distance for a shift of the focal length of the lens groups 61 toward the wide-angle side according to the focal length of the lens groups 51 of the first embodiment. It is also possible in the present embodiment to add the structure of the second embodiment for setting the number of pixels.

In the above embodiments, the first, second and third images are written to the memory card irrespective of presence of the principal object in the first, second and third images. Furthermore, it is possible to check whether a principal object is present in each of the first, second and third images by use of a principal object detection device with the CPU. For example, if the principal object is present in the second image but not present in the first and third images constituting a three-dimensional image, then it is possible to delete the first and third images and store only the second image in the memory card. Also, it is possible to check whether a principal object is present in each of the first, second and third images before writing to a memory card, and to store only images in presence of the principal object (for example, second image) in the memory card.

In the above embodiments, the second camera unit is constructed equally with the first camera unit. When the lens system of the first camera unit is zoomed to the wide-angle end position (widest angle side), the lens system of the second camera unit is also zoomed to the wide-angle end position. However, the second camera unit can be a type of which the lens system can be zoomed to the wider-angle side than that in the first camera unit. The lens system in the second camera unit can be moved to the wider-angle side than the wide-angle end position of the lens system in the first camera unit. Possibility of photographing an object missed from the first camera unit with the second camera unit can be increased.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A three-dimensional image pickup apparatus comprising:
first and second camera units for receiving entry of object light, and for picking up first and second images with parallax simultaneously;
first and second lens systems, incorporated in respectively said first and second camera units, having a focal length changeable in a zooming range for zooming;
a focal length adjusting device for changing said focal length of said second lens system toward a wider-angle side than said focal length of said first lens system;
a processor for forming a third image from said second image with an angle of view equal to an angle of view of said first image;
a three-dimensional image processor for producing a three-dimensional image from said first and third images;
a medium controller for storage processing of said first, second and third images, or said first and second images and a value of said focal length upon picking up said first image.

2. A three-dimensional image pickup apparatus as defined in claim 1, wherein said processor forms said third image by trimming of said second image.

3. A three-dimensional image pickup apparatus as defined in claim 1, wherein said focal length adjusting device enlarges a lens moving distance for zooming said second lens system toward a wide-angle side according to zooming of said first lens system toward a telephoto end position.

4. A three-dimensional image pickup apparatus as defined in claim 3, wherein said zooming range is equal between said first and second lens systems;
said focal length adjusting device, if said first lens system is in a wide-angle end position in said zooming range, sets said second lens system in a wide-angle end position, and if said first lens system is deviated from said wide-angle end position, sets said second lens system nearer to said wide-angle end position than said first lens system.

5. A three-dimensional image pickup apparatus as defined in claim 1, further comprising a number input device for inputting a pixel number of pixels of an image for storage processing with said medium controller, to change a lens moving distance for zooming said second lens system toward a wide-angle side according to said pixel number.

6. A three-dimensional image pickup apparatus as defined in claim 1, further comprising a principal object detector for detecting a principal object from said first image, to change a lens moving distance for zooming said second lens system toward a wide-angle side if said principal object is in a first condition.

7. A three-dimensional image pickup apparatus as defined in claim 6, wherein said first condition is at least one selected from a group including:
a condition in which said principal object is positioned at an end of said first image;
a condition of said principal object with motion; and
a condition in which an object distance of said principal object is equal to or smaller than a predetermined distance.

8. A three-dimensional image pickup method comprising steps of:
picking up first and second images with parallax simultaneously by use of first and second camera units including respectively first and second lens systems of which a focal length is changeable in a zooming range for zooming;
changing said focal length of said second lens system toward a wider-angle side than said focal length of said first lens system;
forming a third image from said second image with an angle of view equal to an angle of view of said first image;
producing a three-dimensional image from said first and third images; and
writing said first, second and third images to a storage medium, or said first and second images and a value of said focal length upon picking up said first image to a storage medium.

9. A three-dimensional image pickup method as defined in claim 8, wherein said third image is formed by trimming of said second image.

10. A three-dimensional image pickup method as defined in claim 8, wherein in said changing step for said focal length, a lens moving distance for zooming said second lens system toward a wide-angle side is enlarged according to zooming of said first lens system toward a telephoto end position.

11. A three-dimensional image pickup method as defined in claim 10, wherein said zooming range is equal between said first and second lens systems;
in said changing step for said focal length, if said first lens system is in a wide-angle end position in said zooming range, said second lens system is set in a wide-angle end position, and if said first lens system is deviated from said wide-angle end position, said second lens system is set nearer to said wide-angle end position than said first lens system.

12. A three-dimensional image pickup method as defined in claim 8, further comprising a step of determining a pixel number of pixels of an image in said storing step, to change a lens moving distance for zooming said second lens system toward a wide-angle side according to said pixel number.

13. A three-dimensional image pickup method as defined in claim 8, further comprising a step of detecting a principal object from said first image, to change a lens moving distance for zooming said second lens system toward a wide-angle side if said principal object is in a first condition.

14. A three-dimensional image pickup method as defined in claim 13, wherein said first condition is at least one selected from a group including:
a condition in which said principal object is positioned at an end of said first image;
a condition of said principal object with motion; and
a condition in which an object distance of said principal object is equal to or smaller than a predetermined distance.
